(19) United States
(12) Patent Application Publication
(10) Pub. No.: US 2006/0126837 A1
(43) Pub. Date: Jun. 15, 2006

(54) Digital recording device for detecting copy protection signal and method thereof

(75) Inventor: Hyoung-Woo Jeon, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/299,970

(22) Filed: Dec. 13, 2005

(30) Foreign Application Priority Data
Dec. 13, 2004 (KR) 2004-104757

(51) Int. Cl. H04N 7/167

(52) U.S. Cl. 380/201

(57) ABSTRACT

A digital recording device and method are disclosed for determining whether to permit signal copying by using a normally received copy generation management system (CGMS) signal. The digital recording device includes a signal input unit to receive an analog signal, a CGMS signal detector to detect a CGMS signal from the analog signal, a noise signal determiner to determine whether the CGMS signal is a noise signal, and a controller to determine whether to permit copying with respect to the analog signal according to information included in the GCMS signal if the CGMS signal is not determined to be a noise signal. Accordingly, whether to permit signal copying accurately determined.

### PRIORITY

This application claims the benefit under 35 U.S.C. §119(a) of Korean Patent Application No. 2004-104757, filed Dec. 13, 2004, in the Korean Intellectual Property Office, the entire disclosure of which is hereby incorporated by reference.

### BACKGROUND OF THE INVENTION

1. Field of the Invention

The present invention relates to a digital recording device for detecting a copy protection signal and method thereof More particularly, the present invention relates to a digital recording device and method for determining whether to permit copying according to whether a received copy generation management system (CGMS) signal is a noise signal.

2. Description of the Related Art

As recently as a few years ago, analog devices such as VCRs were used to record TV broadcast signals. However, digital devices such as DVD players and DVD/VCR combination players are currently available for the home. Such digital devices have the capability of digitizing analog TV signals or analog video signals reproduced from an analog storage medium, then storing the digitized signals to a disc.

In view of the advantageous functions of digital recording devices, current users prefer storing recordings to disc, due, in part, to their high storage capacity rather than to magnetic storage media, such as tape when recording or copying signals. However, disc contents are easily copied by unauthorized individuals, and this unauthorized copying threatens the economic viability of TV broadcasting stations and analog storage medium sellers. Therefore, in order to protect media contents, various copy protection schemes are used. For example, a Macrovision system and a copy generation management system (CGMS) are available for copy protection.

The Macrovision system was developed by Macrovision Corporation, Santa Clara, Calif. According to the Macrovision scheme, a series of electric pulses are aligned with a specific timing and inserted into video signals stored in an original video tape. These pulses do not appear when the original video tape is played back, but operate to degrade image quality if a copied tape is played back. Because these pulses are responsive to an automatic gain control (AGC) device of a recording device, image blurring or noise occur, or no color image is displayed, in the playback of the copied tape.

According to the CGMS copy protection scheme, an image signal is transmitted together with a CGMS signal indicating whether copying is permitted or not. If copying an image signal is not permitted, a recording device does not perform a recording operation. In order to operate the CGMS scheme, a recording device has an ability to recognize the CGMS signal. The analog CGMS standard (CGMS/A) encodes the CGMS signal on the 20th line (first field) and 283rd line (second field) of a national television standard committee (NTSC) broadcast signal. The digital CGMS standard (CGMS/D) is not yet finalized.

Accordingly, if an analog broadcast signal includes a Macrovision signal, a conventional recording device prohibits copying the signal. On the other hand, if an analog broadcast signal includes a CGMS signal, a recording device determines whether to permit copying according to the CGMS signal. However, a noise signal may be inserted during tuning and receiving analog signals from a broadcasting station or in reproducing signals from an analog storage medium due to such occurrences as an electrical surge. In this case, the recording device incorrectly determines the noise signal as the CGMS signal and thus malfunctions. Thus, even if an image signal is identified as being freely copied, the recording device prohibits copying the image signal, or if an image signal is identified as not being restricted, the recording device permits copying.

### SUMMARY OF THE INVENTION

The present invention has been developed in order to solve the above problems. Accordingly, aspects of the present invention provide a digital recording device and method for determining whether to permit copying according to whether a received CGMS signal is a noise signal or not, and a method thereof Aspects of the present invention are directed to analog signals received from a broadcast station, as well as analog signals reproduced from an analog storage medium.

The above and other aspects of the present invention are achieved by providing a digital recording device comprising a signal input unit to receive analog broadcast signals or analog signals reproduced from a storage medium, a copy generation management system (CGMS) signal detector to detect a CGMS signal from the analog signals, a noise signal determiner to determine whether the CGMS signal is a noise signal, and a controller to determine whether to permit copying with respect to the analog signals according to information included in the GCMS signal if the CGMS signal is not determined as a noise signal.

In another exemplary embodiment, the controller permits copying with respect to the analog signals if the CGMS signal is not detected by the CGMS signal detector.

In another exemplary embodiment, the noise signal determiner performs at least one of a plurality of operations comprising checking cyclic redundancy check (CRC) information of the CGMS signal, checking location information of the CGMS signal, and checking copy control information of the CGMS signal a predetermined number of times, and thereby determining whether the CGMS signal is a noise signal or not.

In another exemplary embodiment, the noise signal determiner determines that the CGMS signal is a noise signal when the value of CRC information does not conform to a CRC value of the CGMS signal as a result of checking the CRC information of the CGMS signal. Also, the noise signal determiner determines that the CGMS signal is a noise signal if the location of the CGMS signal does not conform to an analog CGMS standard as a result of checking the location of the CGMS signal. Also, the noise signal determiner determines that the CGMS signal is a noise signal if a value of the copy control information does not conform to an analog CGMS standard value as a result of checking the copy control information of the CGMS signal.

In another exemplary embodiment, the digital recording device further comprises a Macrovision signal detector to detect a Macrovision signal from analog signals, wherein the controller prohibits copying with respect to the analog signals if the Macrovision signal is detected.

In another exemplary embodiment, the digital recording device further comprises a user interface to receive a user selection command, a signal processor to digitize the analog signals if copying command with respect to the analog signals which are permitted to be copied by the controller is input through the user interface, and a signal recorder to store the signals digitized by the signal processor to a digital recording medium.

In another exemplary embodiment, the digital broadcasting device further comprises a tuner to receive analog broadcast signals from an external broadcasting station and output the analog broadcast signals to the signal input unit, and a signal reproducer to reproduce analog signals from an analog recording medium and output the reproduced analog signals to the signal input unit.

The above aspect is also achieved by providing a digital recording method including (a) receiving analog signals, (b) determining whether a CGMS signal is detected from the analog signals, (c) if the CGMS signal is detected, determining whether the CGMS signal is a noise signal, (d) if the CGMS signal is not a noise signal, determining whether to permit copying with respect to the analog signals according to the CGMS signal.

In another exemplary embodiment, the digital recording method further comprises permitting copying with respect to the analog signals if the CGMS signal is not detected.

In another exemplary embodiment, step (c) performs at least one of a plurality of operations comprising checking cyclic redundancy check (CRC) information of the CGMS signal, checking location information of the CGMS signal, and checking copy control information of the CGMS signal a predetermined number of times, and thereby determining whether the CGMS signal is a noise signal or not.

In another exemplary embodiment, step (c) determines that the CGMS signal is a noise signal if the value of the CRC information does not conform to a CRC value of the CGMS signal as a result of checking the CRC information of the CGMS signal. Also, step (c) determines that the CGMS signal is a noise signal if the location information of the CGMS signal does not conform to an analog CGMS standard as a result of checking the location of the CGMS signal. Also, step (c) determines that the CGMS signal is a noise signal if a value of the copy control information does not conform to an analog CGMS standard value as a result of checking the copying control information of the CGMS signal.

In another exemplary embodiment, the digital recording method further comprises detecting a Macrovision signal from analog signals, and prohibiting copying with respect to the analog signals if the Macrovision signal is detected.

In another exemplary embodiment, the digital recording method further comprises receiving a copying command with respect to analog signals that are permitted to be copied, digitizing the analog signals in a predetermined format, and storing the signals digitized by the signal processor to a digital recording medium.

In another exemplary embodiment, step (a) comprises receiving at least one of an analog broadcast signal transmitted from an external broadcasting station and an analog signal reproduced from an analog recording medium.

### BRIEF DESCRIPTION OF THE DRAWINGS

The above aspects, features and advantages of the present invention become more apparent by describing certain exemplary embodiments of the present invention with reference to the accompanying drawings, in which:

FIG. 1 depicts a block diagram illustrating a digital recording device according to an embodiment of the present invention;

FIG. 2 illustrates a copy generation management system (CGMS) signal;

FIG. 3 shows a block diagram illustrating a digital recording device according to another exemplary embodiment of the present invention;

FIG. 4 shows a flowchart illustrating a digital recording method according to an exemplary embodiment of the present invention;

FIG. 5 shows a flowchart illustrating a noise signal determining process according to an exemplary embodiment of the present invention; and

FIG. 6 shows a flowchart illustrating a process of determining whether to permit copying according to the CGMS signal of FIG. 4.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

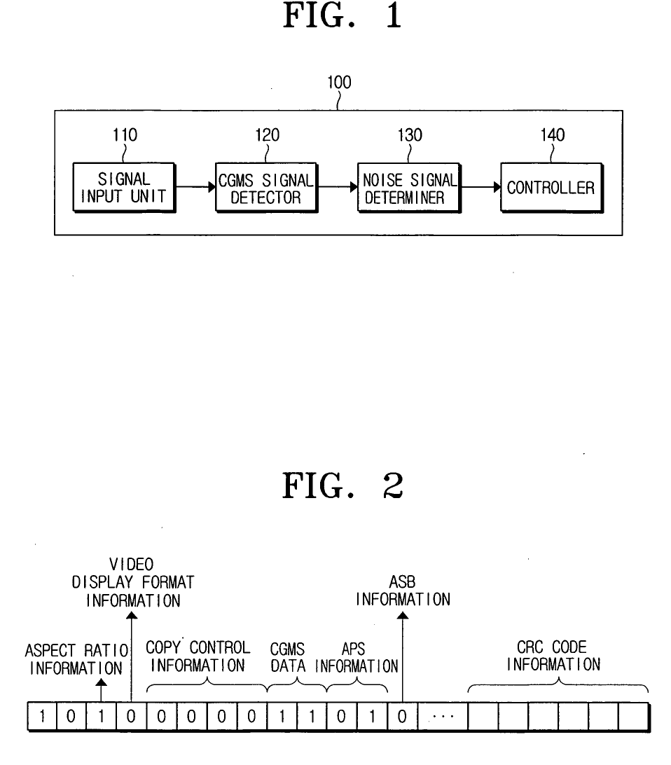

FIG. 1 depicts a block diagram illustrating a digital recording device 100 according to an exemplary embodiment of the present invention. Referring to FIG. 1, the digital recording device 100 comprises a signal input unit 110, a copy generation management system (CGMS) signal detector 120, a noise signal determiner 130, and a controller 140.

The signal input unit 110 receives analog broadcast signals from a broadcasting station or analog signals reproduced from an analog storage medium.

The CGMS signal detector 120 extracts a CGMS signal from the analog signal received through the signal input unit 110. Since the CGMS signal is located on 20th and 283rd lines of a broadcast signal, as described above, the CGMS signal detector 120 detects a signal recorded on the 20th and 283rd lines.

The noise signal determiner 130 determines whether the CGMS signal detected by the CGMS signal detector 120 is a noise signal by comparing the CGMS signal with an analog CGMS standard signal. More specifically, the noise signal determiner 130 performs at least one of a plurality of operations comprising checking the location of the CGMS signal, checking cyclic redundancy check (CRC) information, and checking copy control information. Detailed descriptions will be made below.

The controller 140 disregards the CGMS signal detected by the CGMS signal detector 120 if the CGMS signal is determined to be a noise signal by the noise signal determiner 130. If the CGMS signal is not determined to be a noise signal, the controller 140 checks the CGMS bit setting of the CGMS signal and determines whether to permit copying according to a result of checking the CGMS bit setting. According to the analog CGMS standard, CGMS bits consist of two bits. If the CGMS bits are ‘00’, ‘copy-free’ is determined, if ‘01’, ‘no-more-copy’ is determined, if ‘10’, ‘copy-once’ is determined, and if ‘11’, ‘copy-never’ is determined.

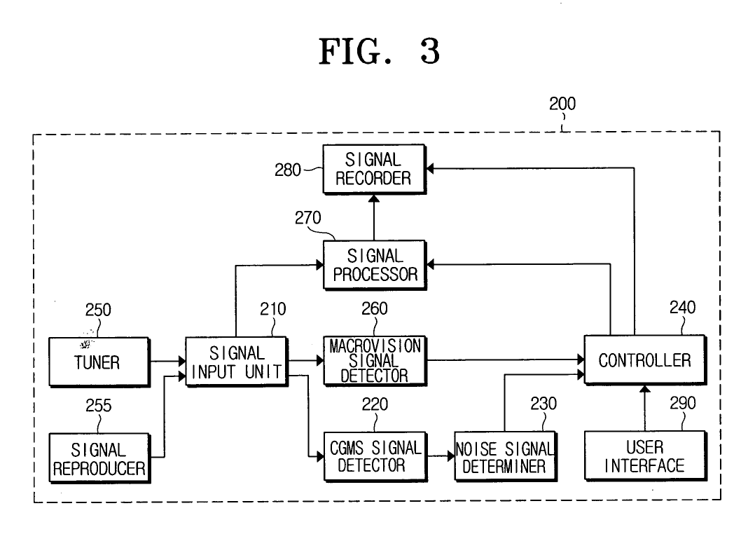

FIG. 2 illustrates a CGMS signal according to the analog CGMS standard. Referring to FIG. 2, the CGMS signal comprises aspect ratio information WDO1, video display format information WDO2, copy control information, CGMS data, analog protection system (APS) information, analog source bit (ASB) information, and cyclic redundancy check (CRC) code information.

The aspect ratio information WDO1 occupies one bit and is recorded in the first bit after the start bit If the WDO1 bit is ‘0’, the controller 140 determines a 4:3 aspect ratio, and if ‘1’, the controller 140 determines a 16:9 aspect ratio. The video display format information WDO2 occupies one bit and is recorded in the bit adjacent to the WDO1 bit. If the WDO2 bit is ‘0’, the controller 140 decides a ‘normal’ display format, and if ‘1’, the controller 140 decides a ‘letterbox’ display format.

The copy control information is 4 bits long. According to the analog CGMS standard, if the CGMS signal comprises CGMS information, the copy control information bits are recorded as ‘0000’, and if the CGMS signal does not include the CGMS information, the copy control information bits are recorded as ‘1111’. That is, according to the analog CGMS standard, the copy control information bits are recorded as either ‘0000’ or ‘1111’. Accordingly, if the copy control information bits are neither ‘0000’ nor ‘1111’, the noise signal determiner 130 determines that the CGMS signal is a noise signal.

The CGMS data is recorded in the next two bits adjacent to the copy control information bits. The CGMS data bits are recorded as ‘00’, ‘01’, ‘10’, or ‘11’.

The APS information is recorded in the two bits adjacent to the CGMS data bits. APS information controls operation of an AGC pulse included in the Macrovision signal and a color burst reversing operation. According to the Macrovision scheme, as described above, a predetermined type of automatic gain control (AGC) pulse signal is inserted in a vertical synchronization portion of a video signal so as to confuse an automatic gain control (AGC) circuit. Also, a part of the color burst signal of horizontal synchronization portion of a video signal is reversed so as to interrupt color image reproduction. If the APS information bit is ‘00’, the controller 140 determines that the AGC pulse is OFF and the color burst reverse is OFF; if ‘01’, the controller 140 determines that the AGC pulse is ON and the color burst reverse is OFF; if ‘10’, the controller 140 determines that the AGC pulse is ON and the color burst reverse is ON (2 lines continuous reverse); and if ‘11’, the controller 140 determines that the AGC pulse is ON and the color burst reverse is ON (four lines continuous reverse).

The ASB information occupies one bit and is recorded in the bit adjacent to the APS information bits. The ASB is information about the types of data storage medium. If the ASB information bit is ‘0’, the controller perceives a digital storage medium, and if ‘1’, the controller perceives an analog storage medium.

The CRC value is recorded to the last portion of the CGMS signal. The CRC value operates as a checksum and is used to determine whether there is damage to a packet. An image signal sender calculates a CRC value of a packet before sending out the packet and adds the calculated CRC value to the packet. Upon receiving the packet, a receiver recalculates the CRC value of the received packet. The CRC value is calculated based on a polynomial expression such as G(x)=x⁶+x+1. The receiver compares the recalculated CRC value with the CRC value added by the sender. If they are equal, the packet is determined to be normal, otherwise the packet is determined as an error. The controller 140 determines whether the CGMS signal is a noise signal by comparing the CRC values.

FIG. 3 is a block diagram illustrating a digital recording apparatus 200 according to another exemplary embodiment of the present invention. Referring to FIG. 3, the digital recording apparatus 200 comprises a signal input unit 210, a CGMS signal detector 220, a noise signal determiner 230, a controller 240, a tuner 250, a signal reproducer 255, a Macrovision signal detector 260, a signal processor 270, a signal recorder 280, and a user interface 290.

The user interface 290 permits a user to input a selection command. If a user presses a button provided on a digital recording device 200, or a remote control unit associated with the device, the user interface 290 perceives the command input through the button selection and notifies the controller 240 of the command. The controller 240 controls overall operations of the system according to the user's selection commands.

The tuner 250 and the signal reproducer 255 output an analog signal to the signal input unit 210, respectively. More specifically, the tuner 250 tunes to a channel used by a certain broadcasting station, receives the analog broadcast signal through the tuned channel, and outputs the signal to the signal input unit 210. The signal reproducer 255 reproduces analog signals from an analog storage medium, such as a tape mounted in a VCR deck, and outputs the reproduced signal to the signal input unit 210.

The Macrovision signal detector 260 detects a Macrovision signal from the analog signals received at the signal input unit 210. The Macrovision signal may be an AGC pulse. According to the NTSC scheme, the Macrovision signal is detected from the 10th to 17th lines of the first field, and the 273rd to 280th lines of the second field. If a Macrovision signal is detected, the controller 240 prohibits the currently received analog signals from being copied freely.

Since operations of the CGMS signal detector 220 and the noise signal determiner 230 are same as those described in connection with FIG. 1, their descriptions are omitted here. The controller 240 determines whether to permit copying according the CGMS signal, which is not determined as a noise signal. That is, if the CGMS data bits are ‘00’ or ‘10’, copying is permitted, and if the CGMS databits are ‘10’ or ‘11’, copying is not permitted.

The signal processor 270 digitizes the analog signals under control of the controller 240 when a recording command is input with respect to an analog signal that is permitted to be copied. The digitized signals are recorded to a digital storage medium, such as a disc, by the signal recorder 280. The signal recorder 280 creates pits on the disc by using an optical pickup and thereby records the data.

The controller 240 displays a message specifying that a recording is not permitted if a recording command is input with respect to an analog signal that is not permitted to be copied.

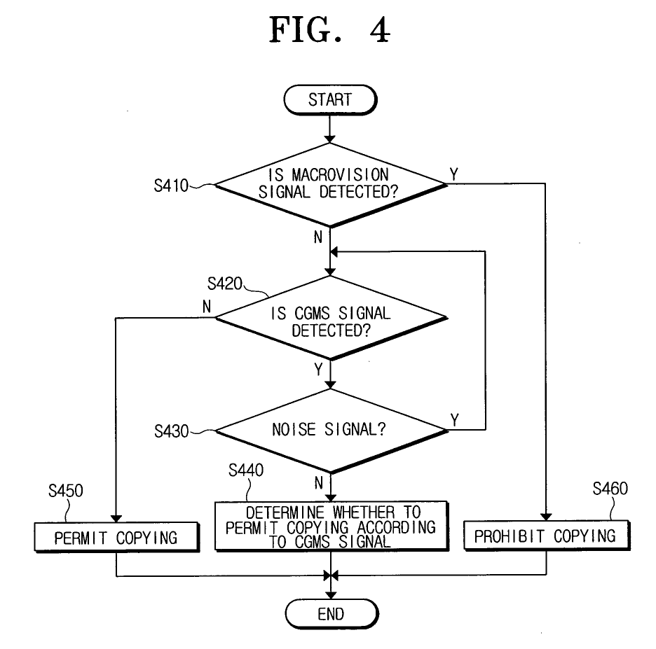

FIG. 4 shows a flowchart illustrating a digital recording method according to an exemplary embodiment of the present invention. Referring to FIG. 4, it is determined whether a Macrovision signal is detected at operation S410. If a Macrovision signal is detected, it is directly determined that no copying is permitted at operation S460, without requiring a step of determining whether a CGMS signal is detected. If a Macrovision signal is not detected, it is determined whether a CGMS signal is detected at operation S420. If CGMS signal is not detected, copying is permitted with respect to a corresponding analog signal at operation S450.

If a CGMS signal is detected, it is determined whether the detected CGMS signal is a noise signal at operation S430. If the detected CGMS signal is determined to be a noise signal, the detected CGMS signal is disregarded. If the detected CGMS signal is not determined to be a noise signal, it is determined whether to permit copying as a result of checking the CGMS data of the detected CGMS signal at operation S440.

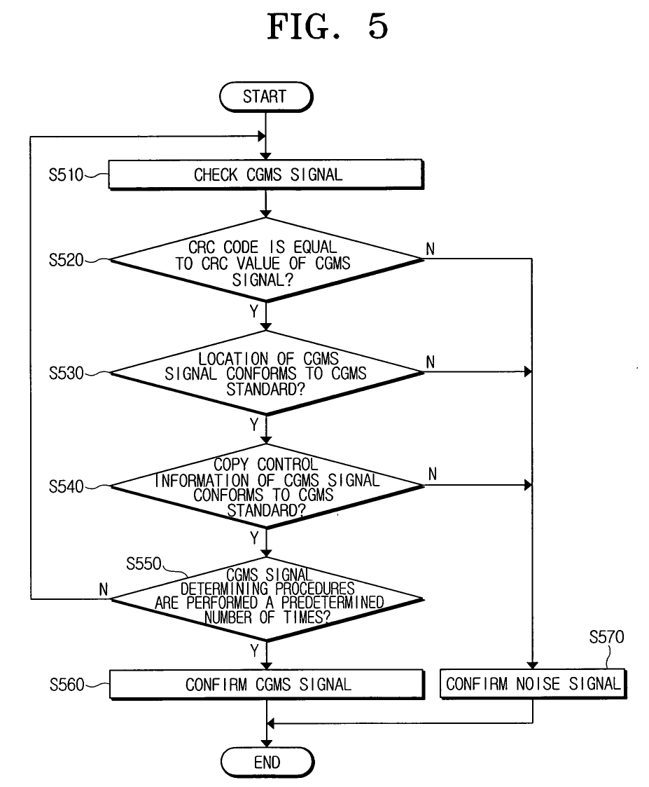

FIG. 5 shows a flowchart illustrating a noise signal determining process according to an exemplary embodiment of the present invention. Referring to FIG. 5, the noise signal determining process checks the detected CGMS signal at operation S510 and determines whether the value of the CRC information is equal to the CRC value of the CGMS signal at operation S520. If the two CRC values are not equal, the detected CGMS signal is determined to be a noise signal at operation S570.

If the value of the CRC information is equal to the CRC value, it is determined whether the location of the CGMS signal conforms to the analog CGMS standard at operation S530. According to the analog CGMS standard, the CGMS signal is determined to be located on the 20th line of the first field and the 283rd line of the second field. Accordingly, if the location of the CGMS signal does not conform to the analog CGMS standard, the detected CGMS signal is determined as a noise signal at operation S570.

If the location of the CGMS signal conforms to the analog CGMS standard, it is determined whether the value of copy control information of the CGMS signal conforms to the analog CGMS standard value at operation S540. That is, it is determined whether the values of copy control information bits are either ‘0000’ or ‘111’. If the value is neither ‘0000’ nor ‘1111’, the CGMS signal is determined as a noise signal at operation S570.

The noise signal determiner 130 (FIG. 1), 230 (FIG. 2) performs one or two of the operations comprising checking the CRC information, checking the location of the CGMS signal, and checking the copy control information, thereby determining whether the CGMS signal is a noise signal.

For more accurate noise signal detection, this determining procedure may be repeated several times at operation S550. If the frequency of noise signal determining procedures is less than a predetermined number, the operations S520 to S540 are repeatedly performed. As a result of this cyclic process, it is finally determined whether the CGMS signal is a noise signal, and if not, the controller 140 (FIG. 1), 240 (FIG. 2) is notified of this determination at operation S560.

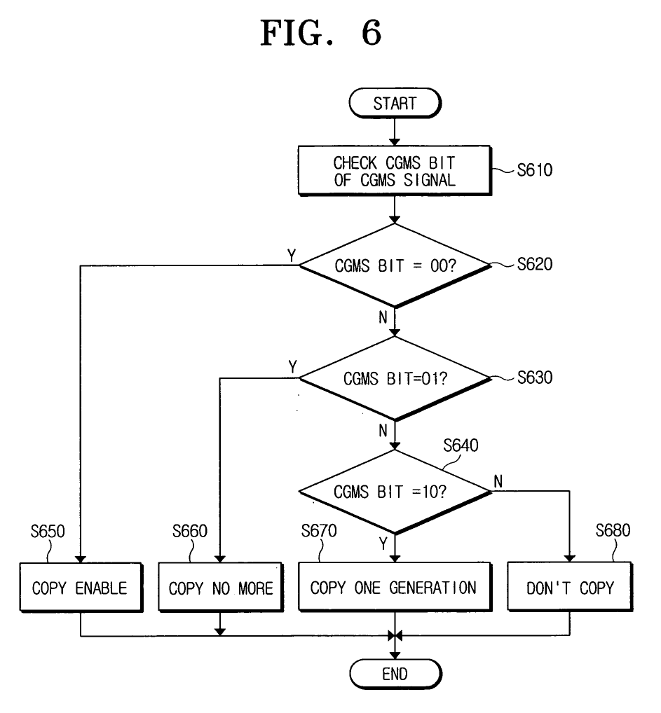

FIG. 6 shows a flowchart illustrating a process of determining whether to permit copying according to the CGMS signal if the CGMS signal is not determined as a noise signal. Referring to FIG. 6, CGMS data bits of the CGMS signal are checked at operation S610. If the values of CGMS bits are ‘00’ at operation S620, copying is permitted at operation S650, if ‘01’ at operation S630, copying is no longer permitted at operation S660, if ‘01’ at operation S640, copying once is permitted at operation S670, and if ‘11’, a copying is prohibited at operation S680.

Accordingly, if a user inputs a recording command, the digital recording device responds to the command according to the result of determining whether to permit a copying. That is, if copying is permitted, the digital recording device digitizes the analog signal and records the signal to a digital storage medium. If copying is prohibited, the digital recording device does not perform the recording operation. In one exemplary embodiment, if a recording command is provided with respect to the ‘copy-never’ signal, the digital recording device displays a message indicating that copying is prohibited.

As described above, it is simply determined whether the CGMS signal is a noise signal. Since whether to permit copying is determined only if a normal CGMS signal is input, it is more accurately determined. Therefore, malfunction of the digital recording device is prevented.

The foregoing embodiments and advantages are merely exemplary and are not to be construed as limiting the present invention. The present teaching can be readily applied to other types of apparauses. Also, the description of the embodiments of the present invention is intended to be illustrative, and not to limit the scope of the claims, and many alternatives, modifications, and variations will be apparent to those skilled in the art. While the present invention has been particularly shown and described with reference to certain exemplary embodiments thereof, it will be understood by those of ordinary skill in the art that various changes in form and detail may be made therein without departing from the spirit and scope of the present invention as defined by the appended claims.

What is claimed is:

1. A digital recording device comprising:
a signal input unit to receive an analog signal;
a copy generation management system (CGMS) signal detector to detect a CGMS signal from the analog signal;
a noise signal determiner to determine whether the CGMS signal is a noise signal; and
a controller to determine whether to permit copying with respect to the analog signals according to information included in the GCMS signal if the CGMS signal is not determined to be a noise signal.

2. The digital recording device as claimed in claim 1, wherein the controller permits copying when the CGMS signal is not detected by the CGMS signal detector.

3. The digital recording device as claimed in claim 2, wherein the noise signal determiner performs at least one of a plurality of operations comprising checking cyclic redundancy check (CRC) information of the CGMS signal, checking location information of the CGMS signal, and checking copy control information of the CGMS signal a predetermined number of times, thereby determining whether the CGMS signal is a noise signal.

4. The digital recording device as claimed in claim 3, wherein the noise signal determiner determines that the CGMS signal is a noise signal when the CRC information does not conform to a CRC value of the CGMS signal as a result of checking the CRC information of the CGMS signal.

5. The digital recording device as claimed in claim 3, wherein the noise signal determiner determines that the CGMS signal is a noise signal when the location of the CGMS signal does not conform to an analog CGMS standard as a result of checking the location of the CGMS signal.

6. The digital recording device as claimed in claim 3, wherein the noise signal determiner determines that the CGMS signal is a noise signal if the copy control information does not conform to an analog CGMS standard value as a result of checking the copy control information of the CGMS signal.

7. The digital recording device as claimed in claim 3, further comprising a Macrovision signal detector to detect a Macrovision signal from the analog signal, wherein the controller prohibits copying the analog signal if the Macrovision signal is detected.

8. The digital recording device as claimed in claim 3, further comprising:
a user interface to receive a user selection command;
a signal processor to digitize the analog signal if a copying command is received through the user interface and the controller permits the analog signal to be copied; and
a signal recorder to store the signals digitized by the signal processor to a digital recording media.

9. The digital broadcasting device as claimed in claim 8, further comprising:
a tuner to receive analog signal from an external broadcasting station and output the analog signal to the signal input unit; and
a signal reproducer to reproduce analog signal received from an analog recording medium and output the reproduced analog signal to the signal input unit.

10. A digital recording method comprising:
(a) receiving an analog signal;
(b) determining whether a CGMS signal is detected from the analog signal;
(c) when the CGMS signal is detected, determining whether the CGMS signal is a noise signal; and
(d) when the CGMS signal is not a noise signal, determining whether to permit copying the analog signal according to the CGMS signal detected.

11. The digital recording method as claimed in claim 10, further comprising permitting a copying the analog signal if the CGMS signal is not detected.

12. The digital recording method as claimed in claim 11, wherein step (c) performs at least one of a plurality of operations comprising checking a cyclic redundancy check (CRC) information of the CGMS signal, checking location information of the CGMS signal, and checking copy control information of the CGMS signal a predetermined number of times, thereby determining whether the CGMS signal is the noise signal.

13. The digital recording method as claimed in claim 12, wherein step (c) determines that the CGMS signal is a noise signal when the CRC information does not conform to a CRC value of the CGMS signal as a result of checking the CRC information of the CGMS signal.

14. The digital recording method as claimed in claim 12, wherein step (c) determines that the CGMS signal is a noise signal when the location of the CGMS signal does not conform to an analog CGMS standard as a result of checking the location of the CGMS signal.

15. The digital recording method as claimed in claim 12, wherein step (c) determines that the CGMS signal is a noise signal if the copy control information does not conform to an analog CGMS standard value as a result of checking the copying control information of the CGMS signal.

16. The digital recording method as claimed in claim 12, further comprising:
detecting a Macrovision signal from the analog signal; and
prohibiting copying the analog signal if the Macrovision signal is detected.

17. The digital recording method as claimed in claim 12, further comprising:
receiving a copying command;
digitizing the analog signal in a predetermined format; and
storing the signals digitized by the signal processor to a digital recording medium.

18. The digital broadcasting method as claimed in claim 10, wherein step (a) comprises receiving at least one of an analog signal transmitted from an external broadcasting station and an analog signal reproduced from an analog recording media.

19. A computer readable medium having stored thereon instructions for digital recording, the instructions comprising:
(a) instructions for receiving an analog signal;
(b) instructions for determining whether a CGMS signal is detected from the analog signal;
(c) when the CGMS signal is detected, instructions for determining whether the CGMS signal is a noise signal; and
(d) when the CGMS signal is not a noise signal, instructions for determining whether to permit copying the analog signal according to the CGMS signal detected.
